(19) United States
(12) Patent Application Publication
(10) Pub. No.: US 2012/0030413 A1
(43) Pub. Date: Feb. 2, 2012

(54) MEMORY MANAGEMENT DEVICE, INFORMATION PROCESSING DEVICE, AND MEMORY MANAGEMENT METHOD

(76) Inventors: Masaki Miyagawa, Kawasaki-shi (JP); Atsushi Kunimatsu, Funabashi-shi (JP); Tsutomu Owa, Kawasaki-shi (JP); Reina Nishino, Yokohama-shi (JP)

(21) Appl. No.: 13/050,528

(22) Filed: Mar. 17, 2011

(30) Foreign Application Priority Data
Jul. 30, 2010 (JP) 2010-172050

(51) Int. Cl. G06F 12/02

(52) U.S. Cl. 711/103; 711/E12.008

(57) ABSTRACT

According to one embodiment, a memory management device configured to manage a main memory including a nonvolatile semiconductor memory, the memory management device includes a sort module configured to sort, at a time of a data write operation in the nonvolatile semiconductor memory, data to write areas of the nonvolatile semiconductor memory, based on information of a frequency of write which is determined by a data attribute of the data, and a control module configured to write the sorted data in the nonvolatile semiconductor memory by an incremental-write type.

### CROSS-REFERENCE TO RELATED APPLICATIONS

This application is based upon and claims the benefit of priority from Japanese Patent Application No. 2010-172050, filed Jul. 30, 2010; the entire contents of which are incorporated herein by reference.

### FIELD

Embodiments described herein relate generally to a memory management device, an information processing device, and a memory management method.

### BACKGROUND

For example, in the case where a nonvolatile semiconductor memory and a volatile semiconductor memory are used as a main memory, there has been proposed a method of determining, in accordance with data attributes, whether a data arrangement area is set in the nonvolatile semiconductor memory or in the volatile semiconductor memory. As an example of the nonvolatile semiconductor memory, a NAND flash memory has been proposed. As an example of the volatile semiconductor memory, a DRAM (Dynamic Random Access Memory) has been proposed.

There are an “overwrite method” and an “incremental-write type” as methods of a data write operation in the nonvolatile semiconductor memory such as a NAND flash memory.

In “overwrite method”, when data at an arbitrary position in an block has been updated, it is necessary to temporarily save all data from the block, to execute an erase process in the block, and then to write the updated data in units of a block.

On the other hand, in the “incremental-write type”, data write is executed in units of a page. In this method, when data has been updated, a mark (invalid data) is added to a page in which the data is present, and the updated data is stored in another page of another block (the same block may be possible).

### BRIEF DESCRIPTION OF THE DRAWINGS

FIG. 1 is a system block diagram illustrating an entire structure example of an information processing device according to an embodiment;

FIG. 2 is a block diagram illustrating a block select module in a processing module in FIG. 1;

FIG. 3 shows a structure example of a coloring table according to the embodiment;

FIG. 4 is a flow chart illustrating a data write operation of a memory management device according to the embodiment;

FIG. 5 is a flow chart illustrating a garbage collection operation of the memory management device according to the embodiment;

FIG. 6 shows a physical block (PEB) after the data write operation according to the embodiment;

FIG. 7 shows a physical block (PEB) after update of data with a high frequency of update in the embodiment;

FIG. 8 shows a physical block (PEB) after update of a data write operation by an overwrite method according to a comparative example;

FIG. 9 shows a physical block (PEB) after update of data with a high frequency of update, by the overwrite method according to the comparative example; and

FIG. 10 shows dirty area sizes in the embodiment and the comparative example.

### DETAILED DESCRIPTION

In general, according to one embodiment, a memory management device configured to manage a main memory including a nonvolatile semiconductor memory, the memory management device includes a sort module configured to sort, at a time of a data write operation in the nonvolatile semiconductor memory, data to write areas of the nonvolatile semiconductor memory, based on information of a frequency of write which is determined by a data attribute of the data; and a control module configured to write the sorted data in the nonvolatile semiconductor memory by an incremental-write type.

Embodiments will now be described with reference to the accompanying drawings. In the description below, common parts are denoted by like reference numerals throughout the drawings.

### Embodiment

### <1. Structure Example

1-1. Entire Structure Example

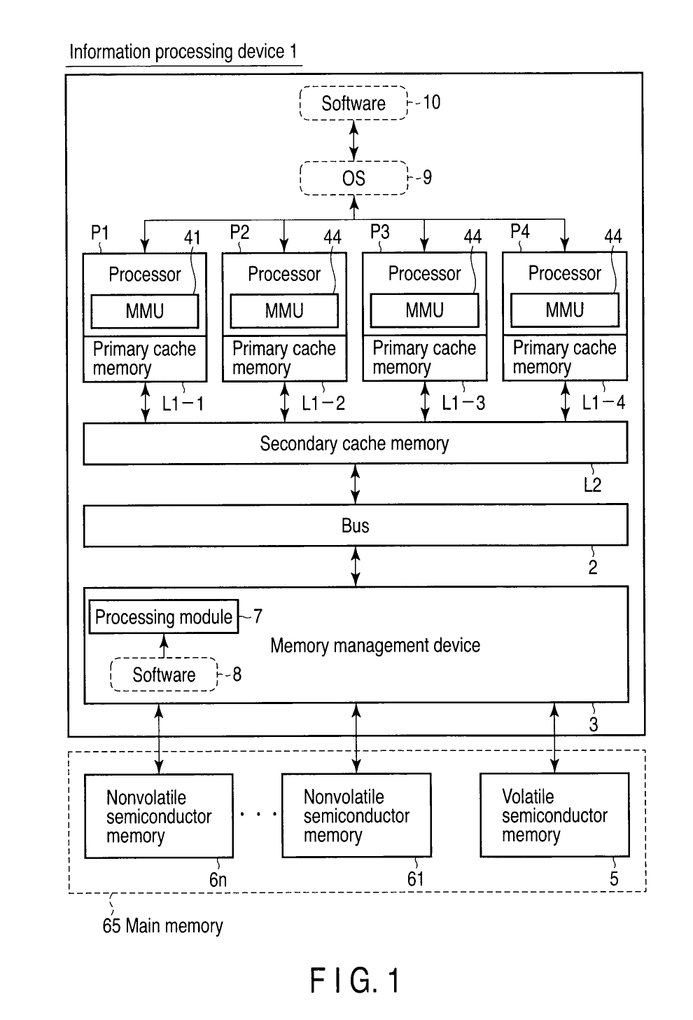

To begin with, referring to FIG. 1, an entire structure example of an information processing device according to an embodiment is described. FIG. 1 is a system block diagram illustrating an example of the structure of an information processing device 1 according to the embodiment.

As shown in FIG. 1, the information processing device 1 is e.g. an SoC (System-on-a-Chip). The information processing device 1 comprises processors P1 to P4, a secondary cache memory L2, a bus 2, and a memory management device 3.

The processors P1 to P4 comprise, respectively, primary cache memories L1-1 to L1-4, and MMUs 41-44. As each of the processors P1 to P4, for example, a CPU (Central Processing Unit) is used. Alternatively, other processing units, such as an MPU (Micro Processor Unit) or a GPU (Graphic Processor Unit), may be used. In FIG. 1, the number of processors P1 to P4 is four. However, the number of processors may be one or more.

The processors P1 to P4 share the secondary cache memory L2, and are electrically connected to the memory management device 3 via the bus 2.

The memory management device 3 is electrically connected to an external volatile semiconductor memory 5, and nonvolatile semiconductor memories 61 to 6n. The processors P1 to P4 can access the volatile semiconductor memory 5 and nonvolatile semiconductor memories 61 to 6n via the memory management device 3.

The processors P1 to P4 and the memory management device 3 are connected such that data can be transmitted/received via the bus 2. In addition, for example, the processors P1 to P4 and the memory management device 3 are operable asynchronously. While the processors P1 to P4 are executing processes, the memory management device 3 can execute wear leveling, garbage collection and compaction for the nonvolatile semiconductor memories 61 to 6n.

In the present embodiment, the information processing device 1, on one hand, and the volatile semiconductor memory 5 and nonvolatile semiconductor memories 61 to 6n, on the other hand, are configured as different chips. However, such a configuration may be adopted that the volatile semiconductor memory 5 and nonvolatile semiconductor memories 61 to 6n are included in the information processing device 1.

A processing module 7 is included in the memory management device 3. An MPU, for instance, is used as the processing module 7. However, another kind of processing unit may be used as the processing module 7.

The processing module 7 controls, based on software 8, various processes for using the nonvolatile semiconductor memories 61 to 6n. In the embodiment, the nonvolatile semiconductor memories 61 to 6n and the processing module 7 may execute, in a sharing manner, the processes for the nonvolatile semiconductor memories 61 to 6n. For example, the software 8 is stored in the nonvolatile semiconductor memories 61 to 6n, and the software 8 is read out from the nonvolatile semiconductor memories 61 to 6n by the processing module 7 at the time of boot-up, and is executed by the processing module 7.

The volatile semiconductor memory 5 and nonvolatile semiconductor memories 61 to 6n are used as a main memory. In the present embodiment, a sufficient memory capacity is secured in the nonvolatile semiconductor memories 61 to 6n. The memory capacity of the nonvolatile semiconductor memories 61 to 6n is larger than the memory capacity of the volatile semiconductor memory 5. For example, data with a higher possibility of access, such as recently accessed data or data with a high frequency of use, is cached from the nonvolatile semiconductor memories 61 to 6n into the volatile semiconductor memory 5. In the case where the processors P1 to P4 access the volatile semiconductor memory 5, if access-target data is not present in the volatile semiconductor memory 5, data transfer is executed between the nonvolatile semiconductor memories 61 to 6n and the volatile semiconductor memory 5. In this manner, by using the combination of the volatile semiconductor memory 5 and nonvolatile semiconductor memories 61 to 6n, the memory space that is larger than the memory capacity of the volatile semiconductor memory 5 can be used as the main memory.

In the present embodiment, it is assumed that the volatile memory 5 is, for instance, a DRAM (Dynamic Random Access Memory). However, as the volatile semiconductor memory 5, the DRAM may be replaced with a memory which is used as a main memory in computers, such as an FPM-DRAM (Fast Page Mode DRAM), EDO-DRAM (Extended Data Out DRAM), or an SDRAM (Synchronous DRAM). If high-speed random access at a level of a DRAM is possible and there is no substantial upper limit to the allowable number of times of access, the volatile semiconductor memory 5 may be replaced with a nonvolatile random access memory such as an MRAM (Magnetoresistive Random Access Memory) or an FeRAM (Ferroelectric Random Access Memory).

In the present embodiment, it is assumed that the nonvolatile memories 61 to 6n are, for instance, NAND flash memories. However, as the nonvolatile semiconductor memories 61 to 6n, other nonvolatile semiconductor memories, such as NOR flash memories, may be used.

Although the volatile semiconductor memory 5 has a smaller capacity (e.g. 128 Mbytes to 4 GBytes) than each of the nonvolatile semiconductor memories 61 to 61n, the volatile semiconductor memory 5 is capable of higher-speed access.

Although each of the nonvolatile semiconductor memories 61 to 6n has a larger capacity (e.g. 32 GBytes to 512 GBytes) than the volatile semiconductor memory 5, the access time of the each of the nonvolatile semiconductor memories 61 to 6n is longer. In addition, in the nonvolatile semiconductor memories 61 to 6n, in a data write operation, it is necessary to once erase data and then to write data. The maximum number of times of write of the nonvolatile semiconductor memories 61 to 6n is limited (e.g. 10,000 or 30,000). If the number of times of write exceeds the limit value, the ratio of error increases, and there are cases in which correct data write cannot be ensured as devices. In addition, in the case of the present example, a data write operation is executed by an “incremental-write type” in the nonvolatile semiconductor memories 61 to 6n.

In the “incremental-write type”, data write is executed in units of a page. In this method, when data has been updated, a mark (invalid data) is added to a page in which the data is present, and the updated data is stored in another page of another block (the same block may be possible). In other words, when the data which is stored at first address is updated, the updated data is stored to the second address (new address) while old data (the data before update) stay the first address. And to recognize which of the data in first address and second address is the update data, for example, invalid flag (mark) is added to the data in first address. An area in which invalid data is stored is called “dirty area” (invalid data area).

If the dirty area increases, a garbage collection operation (to be described later) is more needed, and fragmentation occurs. In other words, the flagmentation is such a phenomenon that the effective area decreases due to the increase of the dirty area. Since such fragmentation occurs, garbage collection is executed.

In the information processing device 1, an OS 9 and software 10, such as an application, are executed by the processors P1 to P4. The processors P1 to P4 execute the OS 9 and software 10, such as an application, in the information processing device 1.

The OS 9 and software 10 are stored, for example, in the primary cache memories L1-1 to L1-4, secondary cache memory L2, volatile semiconductor memory 5 and nonvolatile semiconductor memories 61 to 6n. When the information processing device 1 is operated, the OS 9 and software 10 are read out by the processors P1 to P4.

Access frequency information of physical address spaces of the nonvolatile semiconductor memories 61 to 6n are used by the OS 9 and software 10, and are managed as coloring information by a coloring table in a table format. The access frequency information is representative of the access frequency in units of a page size. The OS 9 determine the access frequency information, based on the characteristics of the program itself, and the distinction of data arranged in a txt area, stack area, heap area and data area of the program, and manages the access frequency information by using the coloring table. The details will be described later.

1-2. Structure Example of Block Select Module

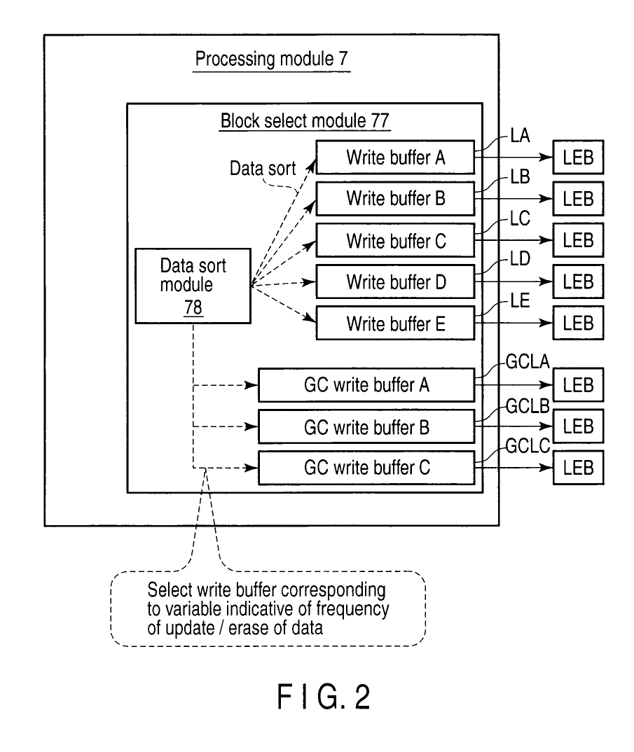

Next, referring to FIG. 2, a description is given of a structure example of a block select module which is included in the memory management device 3 according to the embodiment.

As shown in FIG. 2, in the case of this example, a block select module (processing module) 77 is disposed in the processing module (MPU) 7 in the memory management device 3. However, aside from this example, the block select module 77 may be implemented on a memory controller (not shown) of the NAND flash memory 61 to 6n, or on an FS (File System) for an MTD (Memory Technology Device) (e.g. a file system for a NAND flash memory).

The block select module 77 includes a data sort unit 78, write buffers A to E (LA to L3), and GC write buffers A to C (GCLA to GCLC), and selects data write destination physical blocks of the NAND flash memories 61 to 6n, based on the coloring table (to be described later).

At the time of data write to the NAND flash memories 61 to 6n, the data sort module 78 sorts write data to write areas of the NAND flash memories 61 to 6n, based on information about the frequency of write, which is determined by the data attributes of the write data, and selects the write buffers A to E (LA to LE) which are arranged in accordance with variables indicative of the frequency of data update and the frequency of data erase. The frequency of data update and the frequency of data erase are created based on the coloring table. The details will be described later. In addition, the data sort module 78 similarly selects the GC write buffers A to C (GCLA to GCLC). The details will be described later.

An number of write buffers A to E (LA to LE) are arranged in accordance with variables (a range of 0 to n) indicative of the frequency of update, which is calculated from the coloring table. In other words, each of the write buffers A to E (LA to LE) corresponds to the variable indicative of the frequency of update. In the case of this example, five write buffers A to E (LA to LE) are arranged in accordance with the variables indicative of the frequency of update.

Like the write buffers, a plurality (three in this example) of GC write buffers A to C (GCLA to GCLC) are arranged in accordance with the variables indicative of the frequency of update, which is calculated on the basis of the coloring table.

In the above structure, the block select module 77 executes asynchronous data write by writing the contents of the write buffers A to E (LA to LE) and GC write buffers A to C (GCLA to GCLC) into logical blocks (LEB) by the incremental-write type at an arbitrary timing (for example, at a timing when no task is allocated to the MPU). When the contents of the write buffers A to E (LA to LE) and GC write buffers A to C (GCLA to GCLC) are to be written in the logical blocks (LEB), if no free area is present in the logical blocks (LEB), the logical blocks corresponding to the respective write buffers are changed. The details will be described later with reference to an operational flow chart.

1-3. Structure Example of Coloring Table

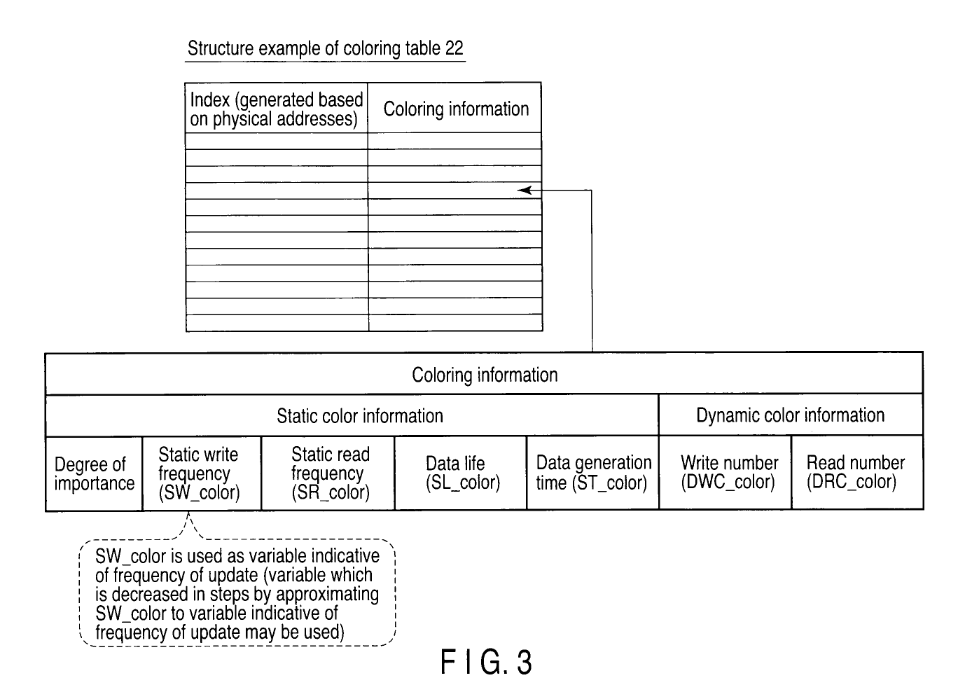

Next, referring to FIG. 3, a structure example of the coloring table according to the embodiment is described. A coloring table 22 is disposed, for example, in the volatile memory 5 or nonvolatile memories 61 to 6n, which are used as the main memory. In the meantime, the coloring table 22 may be stored, for example, in a RAM (not shown) which is provided in the memory management device 3.

As shown in FIG. 3, in the coloring table 22 according to the embodiment, coloring information is given in association with each of indices which are created on the basis of physical addresses of the processors P1 to P4 (logical addresses of the nonvolatile semiconductor memories and volatile semiconductor memory). In this case, the processors P1 to P4 convert the logical addresses of the processors P1 to P4 to the physical addresses of the processors P1 to P4 (logical addresses of the nonvolatile semiconductor memories and volatile semiconductor memory), and send the physical addresses to the memory management device 3.

The data size unit of the data, to which the coloring information is given, is, for example, a minimum unit of read and write. For example, the minimum unit of read and write is a page size of each of the NAND flash memories 61 to 6n. In the description below, the data size of the data, with which the coloring information is associated by the coloring table 22, is described as being the page size. However, the data size is not limited to this example. The coloring table 22 associates the coloring information with each data, and stores the coloring information in units of an entry. Each entry of the coloring table 22 is provided with an index. The index is a value which is generated on the basis of the logical address (physical address of the processor P1 to P4) of data.

For example, when a logical address designating data is given, the memory management device 3, block select module 77 and data sort module 78 refer to the entry managed by the index corresponding to the logical address, and acquire the coloring information of the data in the coloring table 22. Based on the coloring information, the arrangement of the volatile memory (DRAM) 5 and the nonvolatile memories (multi-value memory (MLC: Multi Level Cell), two-value memory (SLC: Single Level Cell)) 61 to 6n is determined. Further, the data sort according to this embodiment is executed in the nonvolatile memories (multi-value memory (MLC: Multi Level Cell), two-value memory (SLC: Single Level Cell)) 61 to 6n. The details will be described later.

The coloring information is information which is used as a reference for determining the area of arrangement of each data in the main memory 65, and includes static color information and dynamic color information. The static color information is information which is generated based on characteristics (data attributes) of the data to which the coloring information is given. The static color information is information which serves as a hint for determining the data arrangement (write) area of the data in the nonvolatile memories 61 to 6n. The dynamic color information is information including at least either the number of times or the frequency of data read and write.

The static color information includes the degree of importance of the data, a value SW_color indicative of a static write frequency, a value SR_color indicative of a static read frequency, a data life SL_color, and ST_color indicative of the time of generation of data.

The degree of importance is a value which is set by estimating the importance of the data, based on the kind of data, etc. The degree of importance is estimated, for example, by the characteristics of a file which is held in the file system, or the characteristic of an area which is primarily used in the program.

The static write frequency SW_color is a value which is set by estimating the frequency of write of the data, based on the kind of data, etc. For example, as the static write frequency SW_color, a higher value is set for data which is estimated to have a higher frequency of write. In the case of this example, the data sort module 78 refers to the static write frequency SW_color in the coloring table 22 as a variable indicative of the frequency of update, and sorts data to the write buffers A to E (LA to LE), based on this variable. Alternatively, the data sort module 78 may sort data by using a variable which is decreased in steps by approximating the static write frequency SW_color to a variable indicative of the frequency of update.

The static read frequency SR_color is a value which is set by estimating the frequency of read of the data, based on the kind of data, etc. For example, as the static read frequency SR_color, a higher value is set for data which is estimated to have a higher frequency of read.

The data life SL_color is a value which is set by estimating, based on the kind of data, etc., the period (life of data) in which the data is used as data without being erased.

The static color information is values which are statically preset by the program (process) for generating data. Besides, a guest OS may estimate static color information, based on a file extension or file header of data.

The dynamic color information includes a data write number DWC_color, and a data read number DRC_color.

The data write number DWC_color is indicative of the number of times of write of the data in the nonvolatile memories 61 to 6n.

The data read number DRC_color is indicative of the number of times of read of the data from the nonvolatile memories 61 to 6n. The memory management device 3 manages the number of times of write of data in the nonvolatile memories 61 to 6n, with respect to each data, on the basis of the data write number DWC_color. The memory management device 3 manages the number of times of read of data from the nonvolatile memories 61 to 6n, with respect to each data, on the basis of the data read number DRC_color. As has been described above, the nonvolatile memories 61 to 6n are used as the main memory. Thus, the data, which is processed by the processors P1 to P4, is written in the nonvolatile memories 61 to 6n, and is read out from nonvolatile memories 61 to 6n.

Each time data is written, the memory management device 3 increments the data write number DWC_color. In addition, each time data is read out, the memory management device 3 increments the data read number DRC_color.

As described above, the frequency of update of data is calculated from the coloring table 22. In the meantime, in the present embodiment, the term “frequency of update” means the frequency with which data is changed (updated) by the processors P1 to P4.

Moreover, in the present embodiment, at the time of a garbage collection operation (to be described later), the data write number DWC_color and data read number DRC_color in the coloring table 22 are referred to, and thereby the times of record of data write and data read of the nonvolatile memories 61 to 6n are referred to, and the data sort of the GC write buffers A to C (GCLA to GCLC) is executed. Thus, the last access times, which are used in the GC write buffers A to C (GCLA to GCLC), are added to the data write number DWC_color and data read number DRC_color in the coloring table 22. In the last access times, the last times of data write and data read are recorded.

### <2. Data Write Operation>

2-1. Data Write Operation Flow.

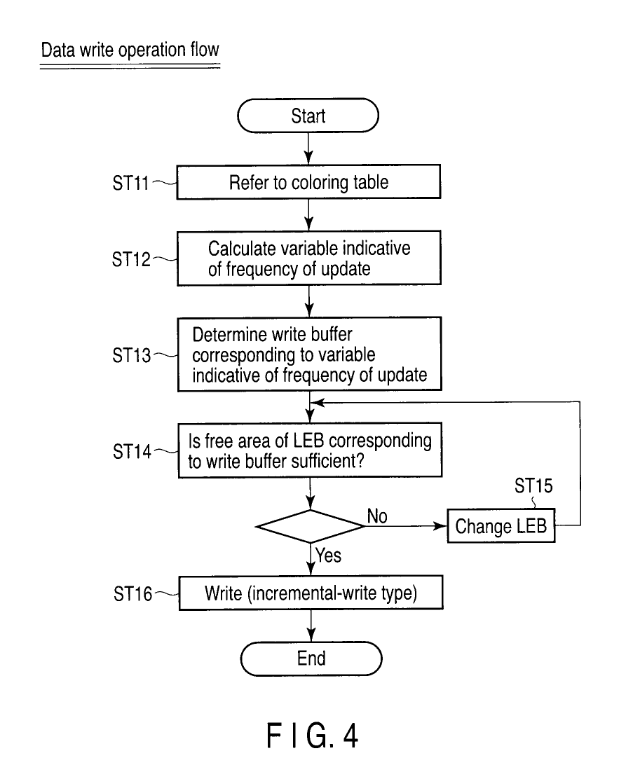

Next, referring to FIG. 4, a description is given of a data write operation of the information processing device according to the embodiment.

(Step ST11)

As shown in FIG. 4, to start with, in step ST11, the data sort module 78 in the block select module 77 refers to the coloring table 22 shown in FIG. 3. To be more specific, in the case of this example, the data sort module 78 refers to the static write frequency SW_color in the coloring table 22 as a variable indicative of the frequency of update.

(Step ST12)

Subsequently, in step ST12, the data sort module 78 calculates the variable indicative of the frequency of update, based on the coloring table 22 which has been referred to. To be more specific, the data sort module 78 calculates the variable indicative of the frequency of update (in this example, variable: 0 to 4), based on the above-described static write frequency SW_color which has been referred to. However, aside from the case of this example, the data sort module 78 may calculate a variable which is decreased in steps by approximating the static write frequency SW_color to a variable indicative of the frequency of update. For example, the variables, which are decreased in steps by approximating the static write frequency SW_color to a variable indicative of the frequency of update, refer to variables which are decreased in steps, such as variables 0 and 1 for the first write buffer, variables 2 and 3 for the second write buffer, variables 4 and 5 for the third write buffer, and variables 6 and 7 for the fourth write buffer, in the case where the first to fourth write buffers are disposed and the variables are 0 to 7.

(Step ST13)

Subsequently, in step ST13, based on the variable indicative of the frequency of update, which has been calculated in step ST12, the data sort module 78 determines the write buffer corresponding to this variable.

In the case of this example, the data sort module 78 determines the write buffers A to E (LA to LE) corresponding to variables (0 to 4), based on the variables (0 to 4) indicative of the frequency of update which has been calculated in step ST12. In the case of this example, as regards the variables (0 to 4) indicative of the frequency of update, it is assumed that the frequency of update decreases as the variable successively increases. Accordingly, the frequencies of update in the write buffers A to E (LA to LE) corresponding to the variables (0 to 4) successively decrease. In short, in the case of this example, data with the highest frequency of update is allocated to the write buffer A (LA).

(Step ST14)

Subsequently, in step ST14, the block select module 77 determines whether the free areas of the logical blocks (LEB), which correspond to the write buffers A to E (LA to LE), are sufficient.

(Step ST15).

Subsequently, in step ST15, when it has been determined in step ST14 that the free areas of the logical blocks (LEB) are not sufficient (No), the block select module 77 changes the corresponding logical blocks (LEB), and returns to the above-described step ST14.

(Step ST16)

Thereafter, in step ST16, when it has been determined in step ST14 that the free areas of the logical blocks (LEB) are sufficient (Yes), the block select module 77 instructs the logical blocks (LEB) to write the data, which has been sorted to the write buffers A to E (LA to LE), by the “(address) incremental-write type” (End).

Subsequently, the data, which has been written in the logical block (LEB) by the incremental-write type, is written in the physical block of the corresponding physical address of the nonvolatile memory, 61 to 6n, by the same “incremental-write type”, with reference to a logical/physical conversion table (not shown).

As described above, with respect to the data that is the object of write, the write areas on the nonvolatile semiconductor memories 61 to 6n are sorted based on the information about the frequency of write which is determined by the data attribute of the data that is the object of write.

2-2. Garbage Collection Operation Flow

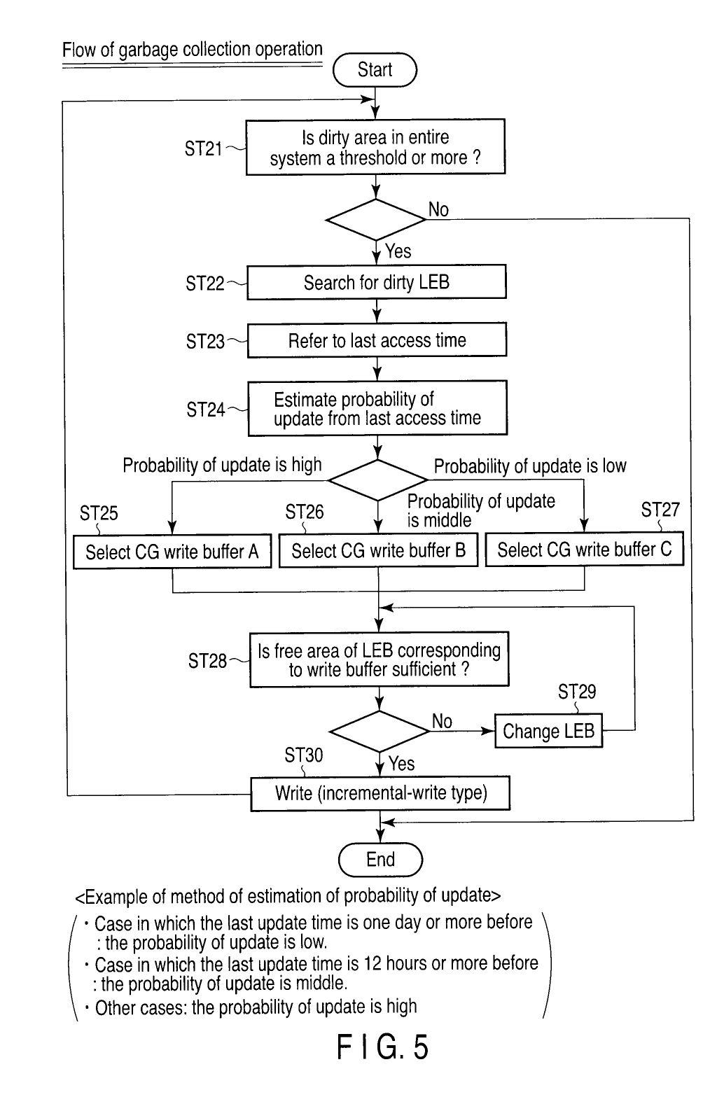

Next, referring to FIG. 5, a description is given of a garbage collection operation of the information processing device according to the embodiment.

In the present embodiment, as regards the garbage collection (GC) of data sort is executed by using the coloring table 22, and data write is executed by the incremental-write type. In this case, when the data which has been written by the “incremental-write type” is updated, a mark (invalid data) is added to the block page in which this data is present, and the updated data is stored in another page of another block (the same block is possible). In other words, an area in which invalid data is added becomes a dirty area. If the dirty area in the logical block (LEB) has increased, an instruction is issued by the garbage collection to write effective data, which has not become invalid, in another logical block (LEB) by the incremental-write type, and to move the effective data. Thus, the garbage collection is a process for setting a logical block (LEB), in which the dirty area has increased, to be an object of erase, and the logical block, in which the dirty area has increased, is made re-usable. Since the effective usable areas in the nonvolatile memories 61 to 6n are increased by the garbage collection operation, the fragmentation can further be improved.

In the case of this example, the garbage collection operation is activated while the processing module (MPU) 7 in the memory management device 3 is in the idle state.

(Step ST21)

As illustrated in FIG. 5, to start with, in step ST21, the data sort module 78 in the block select module 77 determines whether the entire dirty area of nonvolatile semiconductor memory 61-6n is a threshold value or more. If it is determined that the entire dirty area of the information processing device system 1 is not a threshold value or more (No), it is determined that the garbage collection operation is needless, and this operation is finished (End). The threshold value in this case may be varied, where necessary. To be more specific, the data sort module 78 executes this determination, for example, by determining whether the dirty area is 50% or more in the entirety of the nonvolatile memories 61 to 6n.

(Step ST22)

Subsequently, in step ST22, if it is determined that the entire dirty area of the information processing device system 1 is a threshold value or more (Yes), the data sort module 78 searches for the logical block (LEB) of the dirty area in the main memory. To be more specific, the data sort module 78 secures, for example, a list of logical blocks in which data is present, on the nonvolatile memories 61 to 6n, and linearly searches for logical blocks corresponding to the entries of the list.

(Step ST23)

Subsequently, in step ST23, the data sort module 78 refers to the coloring table 22, thereby referring to the last access time of the data that is the object of garbage collection. To be more specific, the data sort module 78 refers to the data write number DWC_color and data read number DRC_color in the coloring table 22, thereby referring to the times at which the data write and data read of the data that is the object of garbage collection are recorded.

(Step ST24)

Following the above, in step ST24, based on the last access time that has been referred to in step ST23, the data sort module 78 estimates the probability of update. To be more specific, in the case of this example, three probabilities of update (high, middle low) are estimated based on the referred-to last access time.

For example, the three probabilities of update in the case of this example in step ST24 are determines as follows.

<Example of Method of Estimation of Probability of Update>

Case in which the last update time is one day or more before: the probability of update is low.

Case in which the last update time is 12 hours or more before: the probability of update is middle.

Other cases: the probability of update is high.

(Step ST25)

Subsequently, in step ST25, if the probability of update has been determined to be “high” in step ST23, the data sort module 78 selects the GC write buffer A (LA).

(Step ST26)

Subsequently, in step ST26, if the probability of update has been determined to be “middle” in step ST23, the data sort module 78 selects the GC write buffer B (LB).

(Step ST27)

Subsequently, in step ST27, if the probability of update has been determined to be “low” in step ST23, the data sort module 78 selects the GC write buffer C (LC).

(Step ST28)

Thereafter, in step ST28, the block select module 77 determines whether the free area of the logical block (LEB) corresponding to the GC write buffer, A to C (GCLA to GCLC), is sufficient or not.

(Step ST29)

In subsequent step ST29, if it is determined in step ST28 that the free area of the logical block (LEB) corresponding to the GC write buffer, A to C (GCLA to GCLC), is not sufficient (No), the block select module 77 changes the corresponding logical block (LEB).

(Step ST30)

In subsequent step ST30, if it is determined in step ST28 that the free area of the logical block (LEB) corresponding to the GC write buffer, A to C (GCLA to GCLC), is sufficient (Yes), the block select module 77 similarly writes the data, which has been sorted to the GC write buffers A to C, in the logical blocks (LEB) by the incremental-write type, and finishes this operation (End).

Thereafter, the data, which has been written in the logical blocks (LEB) by the incremental-write type, is written by the similar incremental-write type in the physical blocks of the corresponding physical addresses of the nonvolatile memories 61 to 6n, by a memory controller (not shown) with reference to the logical/physical conversion table.

As has been described above, in the present embodiment, the coloring table 22 is referred to at the time of the garbage collection operation. Thereby, the probability of future access is estimated from the last access time, and the logical block (LEB) at the destination of data move can be determined. The reason is that the probability of future access can be determined to be higher as the last access time is more recent. Since the effective usable area of the nonvolatile memories 61 to 6n increases by the garbage collection operation which is executed in addition to the data write operation by the incremental-write type of the embodiment, the fragmentation can further be improved.

### <3. Advantageous Effects>

According to the memory management device, information processing device and memory management method of the present embodiment, at least the following advantageous effects (1) and (2) can be obtained.

(1) Occurrence of fragmentation can be suppressed, and the memory can effectively be used.

As has been described above, in the memory management device 3 according to the embodiment, at the time of the data write operation, the data sort module 78 estimates the frequency of update of data, from the attributes of data by referring to the coloring table 22, and determines the write buffer corresponding to the variable indicative of the frequency of update (ST13). When the write buffer corresponding to the variable is determined, the frequency of data erase may be used in place of the frequency of data update.

In the case of this example, the data sort module 78 determines the write buffers A to E (LA to LE) corresponding to variables (0 to 4), based on the variables (0 to 4) indicative of the frequency of update which has been calculated in step ST12. In the case of this example, it is assumed that the frequency of update decreases as the variable (0 to 4) successively increases. Accordingly, the frequencies of update in the write buffers A to E (LA to LE) corresponding to the variables (0 to 4) successively decrease. In short, in the case of this example, data with the highest frequency of update is allocated to the write buffer A (LA).

Further, the memory management device 3 writes the data, which has been sorted to the write buffers A to E (LA to LE), in the logical block (LEB) by the “incremental-write type” (ST16).

As a result, in the nonvolatile memories 61 to 6n, the data corresponding to the frequency of update is collectively written by the same incremental-write type in each of the physical blocks (PEB) of the corresponding physical addresses.

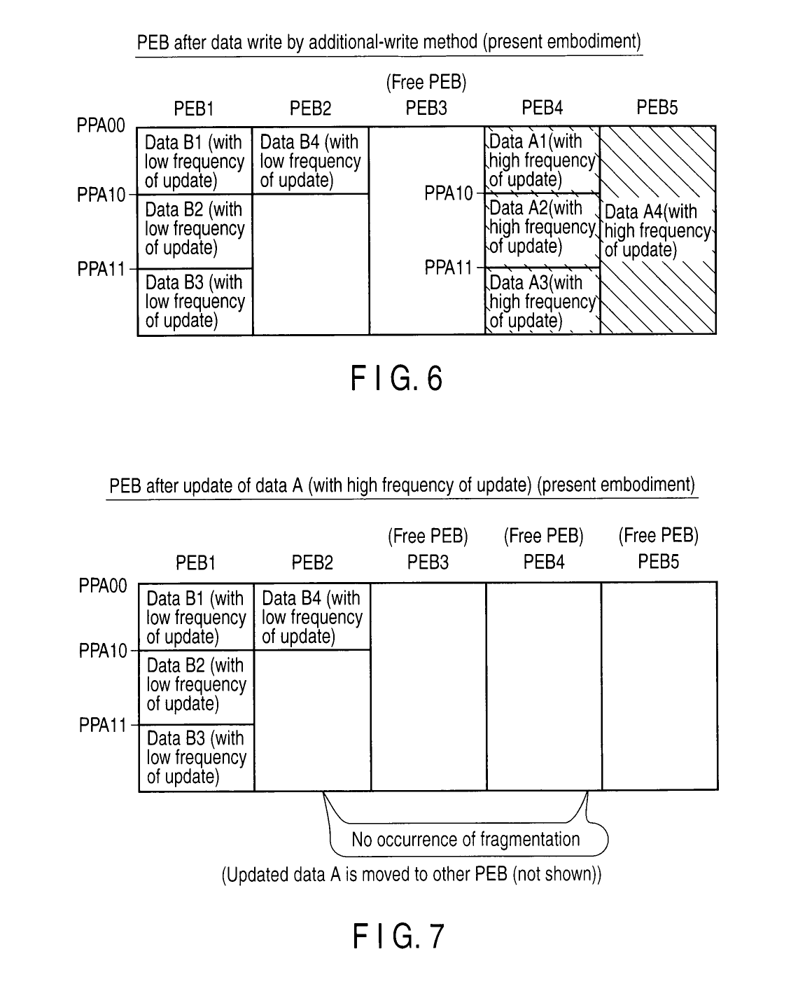

For example, physical blocks (PEB) after data write by the incremental-write type according to the embodiment are as shown in FIG. 6.

As shown in FIG. 6, in a physical block 1 (PEB1), data B1 to B3 with a low frequency of update are written at physical addresses PAA00 to PAA11.

In a physical block 2 (PEB2), data B4 with a low frequency of update is written at a physical address PAA00.

A physical block 3 (PEB3) is a free physical block.

In a physical block 4 (PEB4), data A1 to A3 with a high frequency of update are written at physical addresses PAA00 to PAA11.

In a physical block 5 (PEB5), data A4 with a high frequency of update is written at a physical address PAA00.

In this manner, according to the data write operation by the incremental-write type of the present embodiment, the data can be sorted to the physical blocks (PEB) of the nonvolatile memories 61 to 6n in accordance with the frequency of update.

In addition, at the time of the garbage collection operation, too, the memory management device 3 according to the embodiment sorts the data by using the coloring table 22 (ST24), and writes the data by the incremental-write type (ST30).

The data sort with use of the coloring table 22 in step ST24 is executed by estimating the probability of update from the last access time which is referred to. To be more specific, in the case of this example, the three probabilities of update (high, middle low) are estimated based on the referred-to last access time, and the data is sorted to the GC write buffers A to C (GCLA to GCLC).

As a result, for example, physical blocks (PEB) after update of data A (with a high frequency of update) in this embodiment are as shown in FIG. 7.

As shown in FIG. 7, in the physical block 4 (PEB4) and physical block 5 (PEB5) in which the data A1 to A4 with the high frequency of update have been sorted, the data A1 to A4 are updated. Thus, the data A1 to A4 are moved to other physical blocks (not shown) earlier than data B1 to B4.

Subsequently, in the physical block 1 (PEB1) and physical block 2 (PEB2) in which the data B1 to B4 with the low frequency of update have been sorted, the data B1 to B4 are updated. Thus, the data B1 to B4 are moved to other physical blocks (not shown), following the data A1 to A4.

In this manner, the data, which have been sorted according to the frequency of update, are collectively written in units of a block in the incremental-write type. Therefore, the occurrence of a dirty area can be suppressed, and the occurrence of fragmentation can be prevented.

### Comparative Example

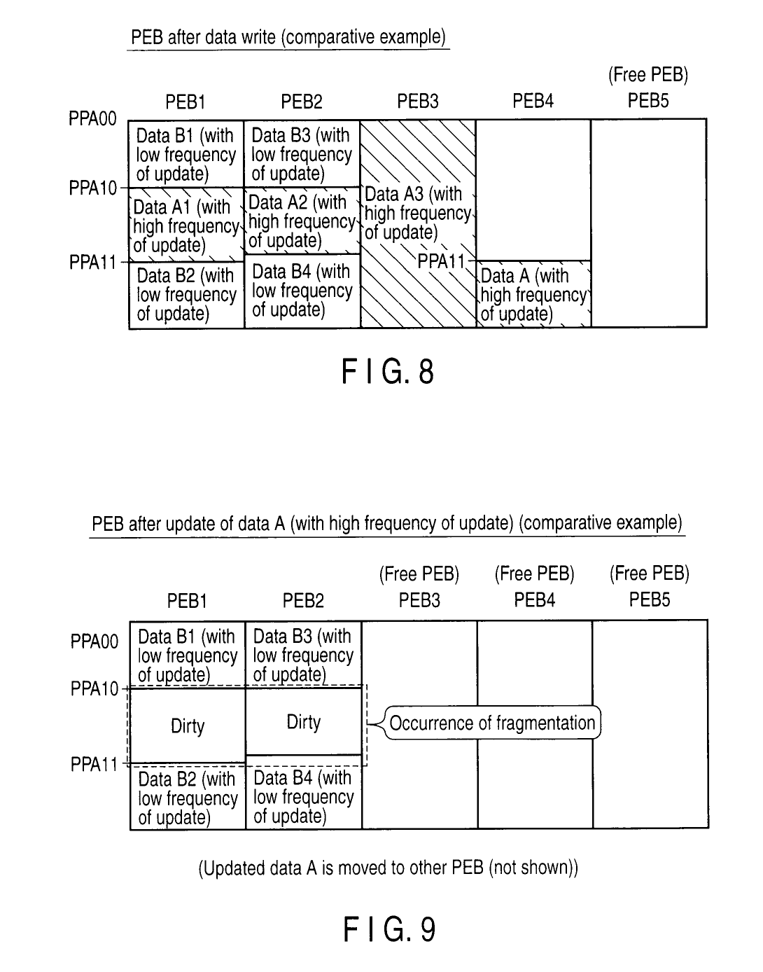

On the other hand, physical blocks (PEB) after data write, in the case where the data sort based on the data attributes as in the present embodiment is not executed in the incremental-write type, are as shown in FIG. 8, for example.

As shown in FIG. 8, in the comparative example, data is not sorted according to the frequency of update, and the data are written in physical blocks.

Consequently, for example, in a physical block 1 (PEB1), data B1 and B2 with a low frequency of update and data A1 with a high frequency of update are written at random at physical addresses PAA00 to PAA11.

In a physical block 2 (PEB2), data B3 and B4 with a low frequency of update and data A2 with a high frequency of update are written at random at physical addresses PAA00, etc.

In a physical block 3 (PEB3), only data A3 with a high frequency of update is written at a physical address PAA00.

In a physical block 4 (PEB4), only data A4 with a high frequency of update is written at random at a physical address PAA11.

A physical block 5 (PEB5) is a free physical block.

In this manner, according to the data write operation of the comparative example, the data is not sorted according to the frequency of update, and the data is written in the physical blocks (PEB).

Consequently, since the data, which have been written at random in the physical blocks (PEB), are moved thereafter in accordance with the frequency of update, random dirty areas occur each time the data is updated.

For example, physical blocks (PEB) after update of the data A (with the high frequency of update) in the comparative example are as shown in FIG. 9.

As shown in FIG. 9, since update is first executed in the physical blocks 1 to 4 (PEB1 to PEB4) in which the data A1 to A4 with the high frequency of update have been written, the data A1 to A4 are moved to other physical blocks (not shown) earlier than the data B1 to B4.

Subsequently, the dirty area increases, and fragmentation occurs disadvantageously.

For example, in the illustrated comparative example, if the data A1 to A4 with the high frequency of update are updated, two dirty areas occur in the physical blocks 1 and 2 (PEB1 and PEB2). A similarly case also occurs when the data B1 to B4 are subsequently updated.

(2) Write amplification (WA) and the performance of the entire system of information processing device 1 can be improved.

As has been described above, at the time of the garbage collection operation, too, the memory management device 3 according to the embodiment sorts the data by using the coloring table 22 (ST24), and writes the data by the incremental-write type (ST30).

The data sort with use of the coloring table 22 in step ST24 is executed by estimating the probability of update from the last access time which is referred to. To be more specific, in the case of this example, the following three probabilities of update (high, middle low) are estimated based on the referred-to last access time, and the data is sorted to the GC write buffers A to C (GCLA to GCLC).

<Example of Method of Estimation of Probability of Update>

Case in which the last update time is one day or more before: the probability of update is low.

Case in which the last update time is 12 hours or more before: the probability of update is middle.

Other cases: the probability of update is high.

In the same manner as described above, the data, which have been sorted to the GC write buffers A to C (GCLA to GCLC), are written in the physical blocks (PEB) of the nonvolatile memories 61 to 6n by the incremental-write type.

Therefore, the embodiment is advantageous in that, in addition to the above-described data write operation, effective data in physical blocks, in which many invalid data are present, can be moved to other physical blocks, and the physical blocks, in which many invalid data are present, can be made erasable, and thus the effective areas in the nonvolatile memories 61 to 6n can be increased.

If garbage collection occurs too frequently, this is undesirable from the standpoint of write amplification (WA). If the garbage collection occurs too frequently, the write amplification (WA) decreases since an increase in write is necessary due to the characteristics of the nonvolatile memories (NAND flash memories) 61 to 6n and the implementation method of the system. In addition, if the garbage collection frequently occurs, the MMU 41 to MMU 44 need to be more used in the garbage process, leading to degradation in performance of the entire system of the information processing device 1.

For example, in the case of the comparative example illustrated in FIG. 9, since the data is written in the physical blocks (PEB) by an overwrite method, two dirty areas occur in the physical blocks 1 and 2 (PEB1 and PEB2). As a result, the write amplification (WA) decreases, and the performance of the entire system of the information processing device 1 is disadvantageously deteriorated.

On the other hand, in the present embodiment, as illustrated in FIG. 7, the data, which have been sorted to the GC write buffers A to C (GCLA to GCLC), are written in the physical blocks (PEB) of the nonvolatile memories 61 to 6n by the incremental-write type. Accordingly, since the occurrence of dirty areas can be suppressed, the number of times of the garbage collection operation does not increase. As a result, advantageously, the write amplification (WA) can be improved, and the performance of the entire system of the information processing device 1 can be improved.

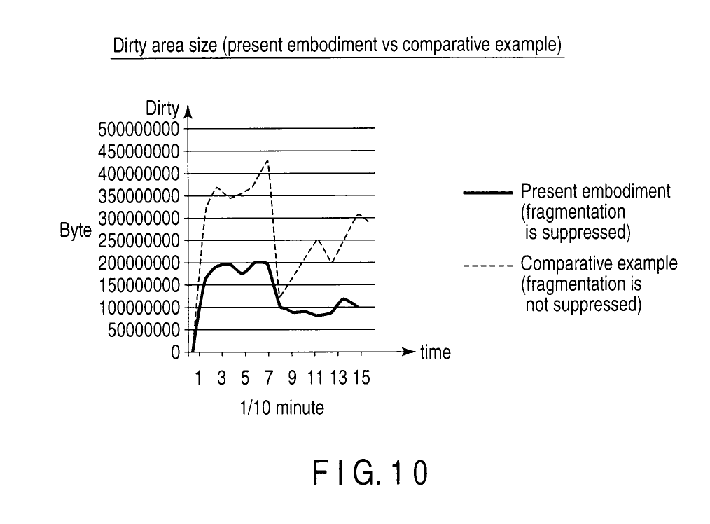

To be more specific, the dirty area sizes in the present embodiment and the comparative example are as shown in FIG. 10. FIG. 10 shows the relationship between time ( 1/10 minute) and the data amount (Byte). A solid line indicates the case of the present embodiment (the above-described fragmentation is suppressed), and a broken line indicates the case of the comparative example (the fragmentation is not suppressed). In FIG. 10, the data amount of the dirty area is small in the neighborhood of time 7 [ 1/10 minute] in each of the cases, because there is a case in which a dirty area is temporarily released when effective data is erased.

As shown in FIG. 10, it is clear that the data amount of the dirty area can be more decreased in the present embodiment than in the comparative example at all times (1 to 15 [ 1/10 minute]).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory management device configured to manage a main memory including a nonvolatile semiconductor memory, the memory management device comprising:
a sort module configured to sort, at a time of a data write operation in the nonvolatile semiconductor memory, data to write areas of the nonvolatile semiconductor memory, based on information of a frequency of write which is determined by a data attribute of the data; and
a control module configured to write the sorted data in the nonvolatile semiconductor memory by an incremental-write type.

2. The device of claim 1, wherein the sort module is configured to sort, at a time of a garbage collection operation of data in the nonvolatile semiconductor memory, data to destinations of move of the data in the nonvolatile semiconductor memory, based on information of a time of last access of the data, and
the control module is configured to write the sorted data in the nonvolatile semiconductor memory by an incremental-write type.

3. The device of claim 1, further comprising a plurality of write buffers which are arranged in accordance with variables associated with the information of the frequency of write which is determined by the data attribute.

4. The device of claim 3, wherein the sort module is configured to sort the data to the plurality of write buffers, based on the calculated variables.

5. The device of claim 2, further comprising a plurality of garbage write buffers which are arranged in accordance with a probability of update.

6. The device of claim 5, wherein the sort module is configured to sort the data to the corresponding plurality of garbage write buffers, based on the probability of update.

7. The device of claim 3, wherein the sort module is configured to sort the data to the plurality of write buffers, by using a static write frequency in information of the data attribute as a variable indicative of a frequency of update, or by using a variable which is decreased in steps by approximating the static write frequency to the variable indicative of the frequency of update.

8. An information processing device comprising:
a memory management device configured to manage a main memory including a nonvolatile semiconductor memory, the memory management device comprising:
a sort module configured to sort, at a time of a data write operation in the nonvolatile semiconductor memory, data to write areas of the nonvolatile semiconductor memory, based on information of a frequency of write which is determined by a data attribute of the data;
a control module configured to write the sorted data in the nonvolatile semiconductor memory by an incremental-write type; and
a processor electrically connected to the memory management device via a bus.

9. The device of claim 8, wherein the sort module is configured to sort, at a time of a garbage collection operation of data in the nonvolatile semiconductor memory, data to destinations of move of the data in the nonvolatile semiconductor memory, based on information of a time of last access of the data, and
the control module is configured to write the sorted data in the nonvolatile semiconductor memory by an incremental-write type.

10. The device of claim 8, further comprising a plurality of write buffers which are arranged in accordance with variables associated within formation of the frequency of write which is determined by the data attribute,
wherein the sort module is configured to sort the data to the plurality of write buffers, based on the calculated variables.

11. The device of claim 9, further comprising a plurality of garbage write buffers which are arranged at the time of the garbage collection operation in accordance with a probability of update,
wherein the sort module is configured to sort the data to the corresponding plurality of garbage write buffers, based on the probability of update.

12. The device of claim 10, wherein the sort module is configured to sort the data to the plurality of write buffers, by using a static write frequency in information of the data attribute as a variable indicative of a frequency of update, or by using a variable which is decreased in steps by approximating the static write frequency to the variable indicative of the frequency of update.

13. A method of managing a main memory including a nonvolatile semiconductor memory, the method comprising:
sorting, at a time of a data write operation in the nonvolatile semiconductor memory, data to write areas of the nonvolatile semiconductor memory, based on information of a frequency of write which is determined by a data attribute of the data; and
writing the sorted data in the nonvolatile semiconductor memory by an incremental-write type.

14. The method of claim 13, further comprising:
determining whether a free area in the write area of the nonvolatile semiconductor memory is sufficient or not, prior to writing the sorted data in the nonvolatile semiconductor memory by the incremental-write type; and
changing the write area when it is determined that the free area is not sufficient.

15. The method of claim 13, further comprising:
sorting, at a time of a garbage collection operation of data in the nonvolatile semiconductor memory, data to destinations of move of the data in the nonvolatile semiconductor memory, based on information of a time of last access of the data, and
writing the sorted data in the nonvolatile semiconductor memory by an incremental-write type.

16. The method of claim 15, further comprising:
determining whether a free area in the write area of the nonvolatile semiconductor memory is sufficient or not, prior to writing the sorted data in the nonvolatile semiconductor memory by the incremental-write type; and
changing the write area when it is determined that the free area is not sufficient.
